(19) United States
(12) Patent Application Publication
(10) Pub. No.: US 2023/0182924 A1
(43) Pub. Date: Jun. 15, 2023

(54) TTC ANTENNA ARRANGEMENT FOR A FLAT SATELLITE

(71) Applicant: THALES, Courbevoie (FR)

(72) Inventors: Nicolas FERRANDO, TOURNEFEUILLE (FR); Philippe LEPELTIER, CASTANET-TOLOSAN (FR); Thierry POPULUS, FONTENILLES (FR)

(21) Appl. No.: 18/076,331

(22) Filed: Dec. 6, 2022

(30) Foreign Application Priority Data
Dec. 9, 2021 (FR) 2113212

(51) Int. Cl. B64G 1/10; B64G 1/36; B64G 1/44

(52) U.S. Cl. CPC B64G 1/1007; B64G 1/36; B64G 1/446

(57) ABSTRACT

A satellite (SAT) includes a platform, at least one solar panel for supplying the satellite (SAT) with electrical energy, the solar panel being fixed along one side of the platform, the satellite comprising an antenna system (Rx+Z, Rx-Z, Tx+Z, Tx-Z) comprising two remote control antennas (Rx+Z, Rx-Z) and two remote measurement antennas (Tx+Z, Tx-Z), wherein the two remote control antennas (Rx+Z, Rx-Z) are disposed back to back on either side of the platform, and spaced one from the other by a distance less than or equal to λ, where λ corresponds to the wavelength of the remote control or remote measurement signal, the two remote measurement antennas (Tx+Z, Tx-Z) are disposed back to back, on either side of the platform, and spaced one from the other by a distance less than or equal to λ, the antenna system is disposed at one of the two ends of the side of the platform (PF) on which the solar panel (PS) is fixed.

### CROSS-REFERENCE TO RELATED APPLICATION

This application claims priority to foreign French patent application No. FR 2113212, filed on Dec. 9, 2021, the disclosure of which is incorporated by reference in its entirety.

### FIELD OF THE INVENTION

The invention relates to the field of satellites, and in particular a satellite comprising an antenna system.

### BACKGROUND

When a satellite is sent into orbit, and throughout its mission, the satellite must be able to communicate at all times with a ground control centre, irrespective of the attitude of the platform.

For this purpose, the satellite disposes of a system known as “TTC” (for “Telemetry, Tracking and Command”).

A remote measurement link allows information relating to the state of the satellite to be transmitted to the control centre through a plurality of measurements. A remote control link allows specific commands to be transmitted, from the control centre, for the processing of any event taking place in the satellite (orbital manoeuvres, equipment tests, anomalies, failures, etc.).

The link must be established irrespective of the attitude of the platform. For this purpose, the TTC antenna system is generally composed of two remote measurement antennas Tx, forming an omnidirectional antenna assembly, and of two remote control antennas Rx, forming an omnidirectional remote control antenna assembly.

One example of a conventional TTC system is shown in FIG. 1.

For the remote measurement, a conventional TTC system comprises a transponder TP1, in order to modulate the remote measurement signals TM coming from the on-board computer OBC of the platform PL, a coupler CP1, which allows the splitting of the signal to be transmitted over each of the antennas, namely a first antenna referred to as earth antenna Tx+Z, and an antenna situated on the other side of the satellite, referred to as anti-earth antenna Tx-Z. The coverage of each antenna is as hemispherical as possible.

In an analogous manner, for the remote control, the TTC system comprises a first antenna referred to as earth antenna Rx+Z, and an antenna situated on the other side of the satellite, referred to as anti-earth antenna Rx-Z, a coupler CP2, for summing the signals received on the two antennas, and a transponder TP2, for demodulating the remote control signals TC, and for transmitting them to the on-board computer OBC of the platform.

The remote control TC and remote measurement TM data may be respectively transmitted to the payload PL or be transmitted by the payload PL, via the on-board computer OBC.

The antennas dedicated to the remote control and the antennas dedicated to the remote measurement may radiate according to different polarizations, for example left and/or right circular polarization, in order to minimize the interference between the two links.

In order to ensure an omnidirectional coverage between the earth antenna and the anti-earth antenna, the earth and anti-earth antennas are disposed in such a manner as to radiate in opposite directions.

Each antenna thus operates within a cone of +/-75°, which is sufficient to ensure a link with the control centre, irrespective of the attitude of the platform, with one or the other of the earth or anti-earth antennas.

Each of the antennas of an earth and anti-earth pair must thus be disposed in a diametrically opposing manner, and in a completely clear location of the platform, notably by disposing the antennas at the end of masts fixed to the platform, or else in two opposite corners of the platform, in order to avoid a part of the satellite masking the hemispherical space in front of the antenna.

When the dimensions of the platforms are large, typically several metres, the antennas of an earth/anti-earth pair are located several metres from one another for the largest platforms, which generates oscillations.

FIG. 2 illustrates the amplitude (in dB) of the signal received by the transponder of a conventional satellite, as a function of the attitude of the satellite, for the remote control link in band C (between 3.4 and 4.2 GHz in reception), when the distance between the earth antenna and the anti-earth antenna is around 100λ, where λ corresponds to the wavelength of the received signal.

The radiation diagram of each individual horn has been modelled mathematically based on measurements performed in an anechoic chamber.

The various horn array configuration curves, calculated based on the mathematical model of the radiation diagram of an individual horn, correspond to the various cross-sectional planes of the antenna. On all the cross-sectional planes of the antenna, large oscillations of the composite signal, greater than 5 dB, appear between +60° and +120° (“ripple” phenomenon). These oscillations, due to the recombination of phases, are detrimental to the link efficiency.

There is currently no solution preventing these oscillations.

The document FR 2 789 652 A1 discloses a satellite for which the duration of manufacturing cycle and of time spent in the integration hall is reduced. The document FR 2 788 179 A1 discloses a method for transmitting signals to a satellite having at least two active redundant antennas and whose diagrams are superposed, for a TTC link.

Furthermore, the emergence of mega-constellations, for example the “Starlink” (trademark) mega-constellation produced by the aerospace manufacturer “SpaceX” (trademark), has led the producers of satellites to develop new satellite architectures.

The maximization of the under-shroud payload volume, for the multiple launches with a large number of satellites, has led to a “flat” satellite configuration.

There is thus a need for improved satellites.

### SUMMARY OF THE INVENTION

The invention aims to overcome the aforementioned drawbacks, by taking advantage of the features of flat satellites.

One subject of the invention is therefore a satellite comprising a platform, at least one solar panel for supplying the satellite with electrical energy, the solar panel being fixed along one side of the platform, the satellite comprising an antenna system comprising two remote control antennas, and two remote measurement antennas, in which
the two remote control antennas are disposed back to back on either side of the platform, and spaced one from the other by a distance less than or equal to λ, where λ corresponds to the wavelength of the remote control or remote measurement signal,
the two remote measurement antennas are disposed back to back, on either side of the platform, and spaced one from the other by a distance less than or equal to λ,
the antenna system is disposed at one of the two ends of the side of the platform on which the solar panel is fixed.

Advantageously, the platform comprises a transponder, the transponder being adjacent to the antenna system.

Advantageously, the two remote control antennas are disposed between the transponder and the two remote measurement antennas.

Advantageously, the transponder is disposed between the two remote control antennas and the two remote measurement antennas.

Advantageously, the platform comprises an arm forming an extension of the platform in the plane of the platform, along an axis corresponding to the junction between the platform and the solar panel, the antenna system being disposed on the said arm of the platform.

Advantageously, the arm of the platform comprises a deployment device, the said deployment device being equipped with a low-impact passive system.

Advantageously, the satellite comprises a first coupler configured for summing signals coming from the remote control antennas, a second coupler configured for distributing a remote measurement signal to the remote measurement antennas, the first coupler and the second coupler being respectively connected between the remote control antennas and between the remote measurement antennas.

### BRIEF DESCRIPTION OF THE DRAWINGS

Other features, details and advantages of the invention will become apparent upon reading the description presented with reference to the appended drawings given by way of example.

FIG. 1 illustrates a block diagram of the TTC system of a satellite, according to the prior art.

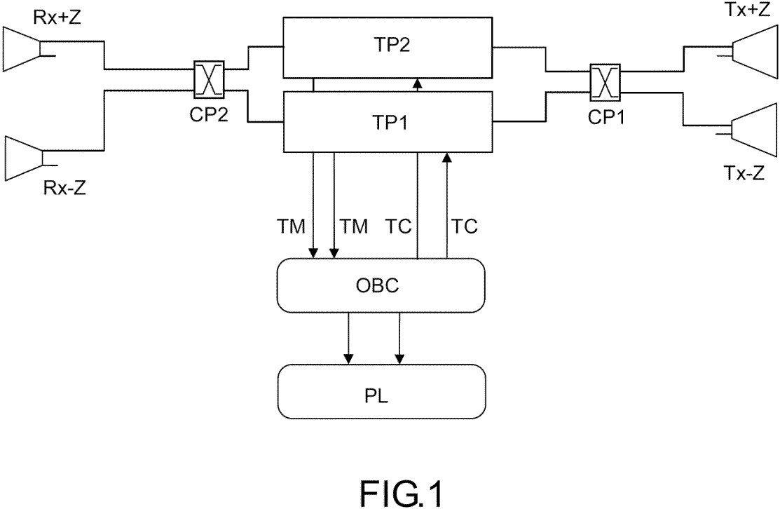

FIG. 2 illustrates the amplitude (in dB) of the signal received by the transponder as a function of the attitude of the satellite, in a satellite of the parallelepipedic type, according to the prior art.

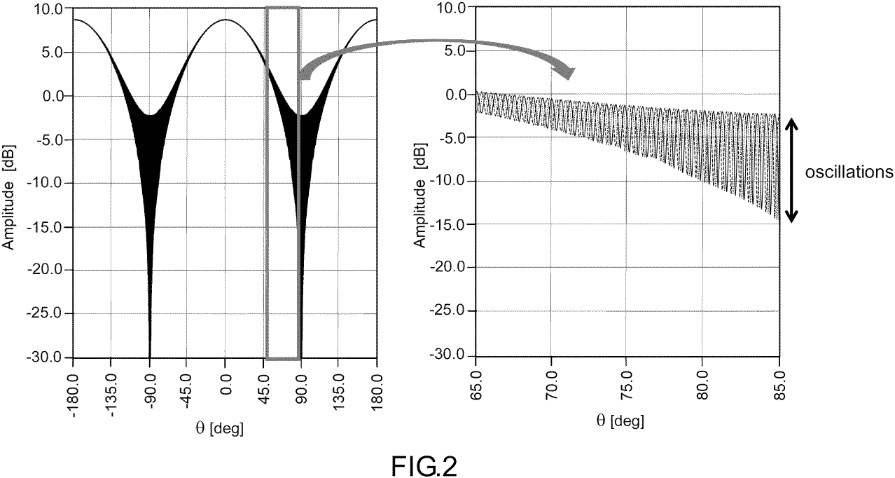

FIG. 3 illustrates a first 3D view of a satellite, according to embodiments of the invention.

FIG. 4 illustrates a second 3D view of a satellite, according to embodiments of the invention.

FIG. 5 illustrates a cross-sectional view of the back-to-back configuration of the pairs of antennas, according to one embodiment of the invention.

FIG. 6 illustrates the amplitudes (in dB) of the signal received by the transponder as a function of the attitude of the satellite, for antennas spaced by a distance equal to 5λ, 2λ, 1λ and 0.5λ, according to embodiments of the invention.

FIG. 7 illustrates a preferred embodiment of arrangement of the coupler between each of the antennas of a antenna pair.

FIG. 8 illustrates the embodiment of the satellite with a deployable arm.

### DETAILED DESCRIPTION

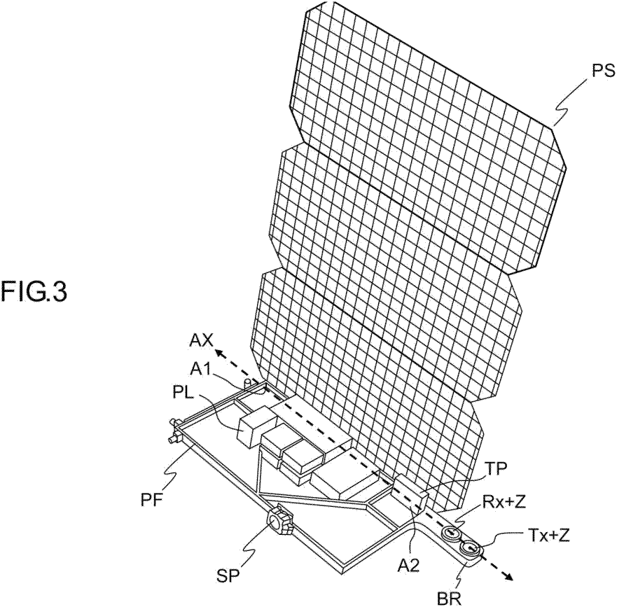

The satellite according to the invention is illustrated in FIG. 3. It comprises a platform PF, of plane structure, as opposed to cubic satellites, or equivalents, whose length/width/height dimensions have the same order of magnitude. Plane structure is thus understood to mean a satellite where the smallest dimension of the platform is less than or equal to λ, where λ corresponds to the wavelength of the remote control or remote measurement signal. The plane structure notably allows, during the launch phase of the satellite, tens of satellites (not deployed) to be stacked within the shroud of the rocket.

The platform may be rectangular, or else take the form of a disc, in order to be adapted to the typical cylindrical shape of the shrouds of rockets. It may also take the form of a half-disc in order to install two satellites side by side on the same level in the shroud of a rocket, or even take the form of a quarter of a disk, in order to install four satellites side by side on the same level in the shroud of a rocket.

It also comprises a propulsion system SP for orbital adjustments. The propulsion system SP may for example comprise Hall effect thrusters (engines which use the energy supplied by the solar panels) which produce their thrust by expelling gas, for example krypton or xenon.

The satellite comprises a payload PL. The payload PL may for example be a telecommunications repeater in the case of a telecommunications mission (telephony, internet, internet of things, etc.), or else an observation payload for earth observation missions, for example in order to carry out an imaging mission.

The satellite also comprises at least one solar panel PS, intended to supply the platform PS and the payload PL with electrical energy. Generally speaking, the satellites comprise several interconnected solar panels, a deployment system then allowing the assembly of solar panels PS to be deployed once in orbit.

The present description mentions a single solar panel, but it may also be applied to the case where an assembly of several solar panels is deployed.

The solar panel PS is attached to one of the sides of the platform. In FIG. 3, the solar panel is fixed over the entire length of one side of the platform PF, along an axis AX, it being understood that the attachment may be effected by legs distributed along the whole length of the side of the platform PF. Other modes of attachment may be envisaged without straying from the framework of the invention.

For example, the solar panel may be fixed to only a part of one side of the platform.

The antenna system, composed of two remote control antennas (Rx+Z, Rx-Z) and of two remote measurement antennas (Tx+Z, Tx-Z), is, according to the invention, disposed at one of the two ends of the side of the platform PF onto which the solar panel is fixed.

By thus disposing the antenna system at the foot of the solar panel PS, in one of the corners (A1, A2) of the platform, only the edge of the solar panel is visible by the antenna system (rather than the whole surface of the solar panel, which is by its nature very reflective), which minimizes the impact of the diffraction and of the multi-path on the solar panel.

This effect is also observable when the antenna system is disposed at one of the two ends of the side of the platform PF, and when the solar panel is fixed onto a part of the length of one side of the platform PF.

The radiation diagram of the antenna system is therefore very little or even not at all degraded by the presence of the solar panel.

The fact that the satellite is flat is thus exploited in order to bring the antennas closer together and to thus avoid the oscillations.

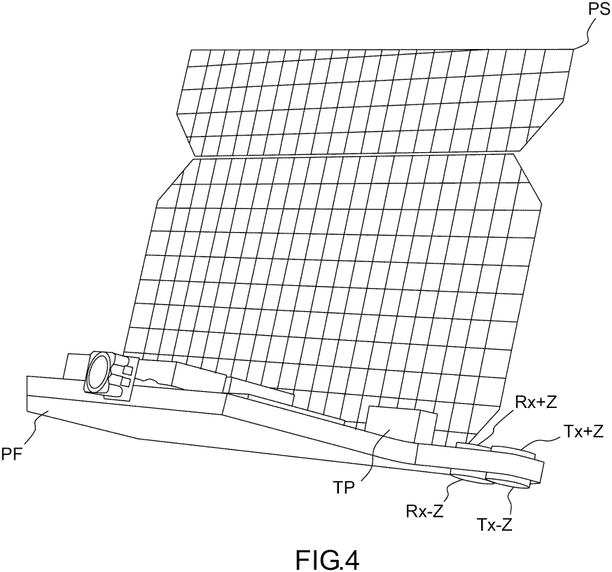

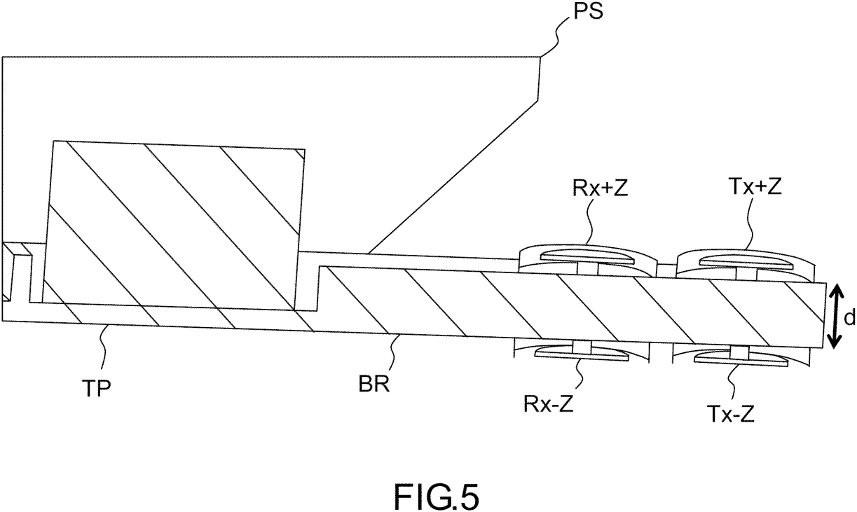

As is illustrated in more detail by FIGS. 4 and 5, the two remote control antennas (earth remote control antenna Rx+Z and anti-earth remote control antenna Rx-Z) are disposed back to back on either side of the platform PF, and spaced one from the other by a distance less than or equal to λ, where λ corresponds to the wavelength of the remote control or remote measurement signal.

Similarly, the two remote measurement antennas (earth remote measurement antenna Tx+Z and anti-earth remote measurement antenna Tx-Z) are disposed back to back, on either side of the platform, and spaced one from the other by a distance less than or equal to λ.

In FIG. 5, the antenna system is composed of antennas of the “patch” type (for example for a use in S band), but other types of antennas may be considered, for example horn antennas (for example for a use in C, X or Ka band).

The phrase “disposed back to back” is understood to refer to the fact that the antennas are opposing one another, or else according to a ‘tête-bêche’ configuration: they are aligned along an axis normal to the plane of the platform, but their radiating axes point in opposite directions.

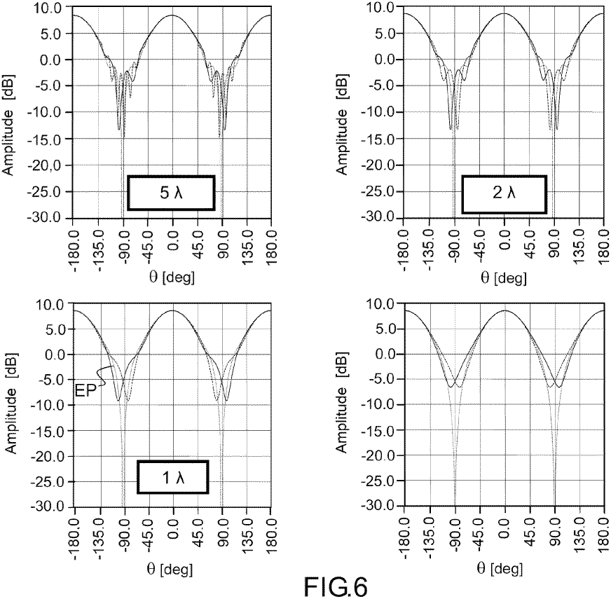

The close spacing between the remote measurement antennas, and also between the remote control antennas, represented by the distance d in FIG. 5, which corresponds to the thickness of the platform PF, greatly reduces the “ripple” phenomenon, as is illustrated by FIG. 6. Indeed, for a spacing less than λ between the remote measurement antennas, or between the remote control antennas, the various diagrams summing the antennas no longer show oscillations appearing when the antennas are configured in an array, irrespective of the attitude of the satellite.

The shoulders EP visible on the diagram for a spacing equal to λ are not considered as being oscillations, because they do not create any ambiguity with respect to the amplitude of the signal. For a spacing greater than λ (for example 5λ or 2λ in FIG. 6), these oscillations are present, which is detrimental to the behaviour of the antenna system.

A better control of the radiation diagram is thus obtained in the absence of oscillations.

The invention also allows a gain in angular coverage. Indeed, in the absence of oscillations, the measurements may be exploited over a wider angular range. The omnidirectional nature of the antenna assembly is thus improved.

The spacing between the pair of remote control antennas and the pair of remote measurement antennas is the object of a compromise between gain in volume and complexity of the filter. Indeed, the remote control antennas typically comprise a filter in order to avoid the energy radiated by the remote measurement antennas interfering with the correct operation of the remote control antennas.

Proximity of the pair of remote control antennas to the pair of remote measurement antennas induces a strong coupling between the two pairs of antennas, which increases the number of resonance poles in the filter of the remote control antennas and which, as a consequence, renders the fabrication of the filter more complex.

The satellite furthermore comprises a transponder TP for demodulating the remote control signal received by the remote control antennas over the uplink, and for modulating the remote measurement signal transmitted by the remote measurement antennas over the downlink. The transponder thus comprises a receiver chain and a transmission chain. The transponder may also take the form of a transponder dedicated to the uplink channel and of a transponder dedicated to the downlink channel.

The transponder takes into account, in the receiver chain, the propagation time of the remote control signal between the ground station and the satellite, together with the Doppler effect linked to the motion of the satellite.

According to one advantageous embodiment, the transponder TP is adjacent to the antenna system, as near as possible to the latter, in order to minimize the length of the cables, and the associated ohmic losses. The minimization of the length of the cables also allows the overall mass of the satellite to be reduced.

As is illustrated by FIGS. 3, 4 and 5, the transponder may thus be disposed in one of the corners of the platform PF, namely the same corner where the antenna system (angle A1 or angle A2) is located.

Placing the transponder in immediate proximity to the antenna system also simplifies the assembly, integration and test operations (known as AIT operations). Indeed, the whole assembly is grouped at the same location on the platform, thus making possible an integration in the form of a module. In a conventional satellite, the assembly comprises a step for installing a remote control antenna and a remote measurement antenna on arms situated opposite to one another, which is much more complex in terms of mechanical attachment and of electrical cabling.

According to one particularly advantageous embodiment, the two remote control antennas (Rx+Z, Rx-Z) are disposed between the transponder TP and the two remote measurement antennas (Tx+Z, Tx-Z), as illustrated in FIGS. 3 to 5.

It is indeed preferable for the pair of receiver antennas to be as close as possible to the transponder in order to limit the losses, hence the noise, before the low-noise amplification section.

As a variant, the transponder TP may be disposed between the two remote control antennas (Rx+Z, Rx-Z) and the two remote measurement antennas (Tx+Z, Tx-Z).

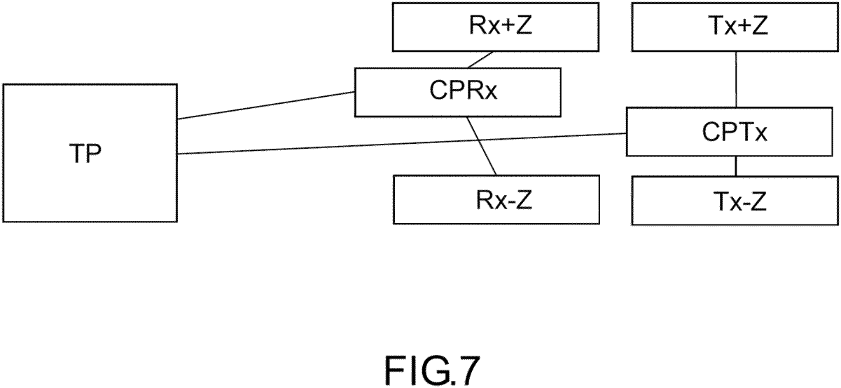

The satellite may also comprise a first coupler CPRx configured for summing the signals coming from the remote control antennas (Rx+Z, Rx-Z), and a second coupler CPTx configured for distributing a remote measurement signal to the remote measurement antennas (Tx+Z, Tx-Z), as illustrated by FIG. 7. The second coupler CPTx may be of the 3 dB/90° type, in order to apply a balanced distribution of the power into two transmission lines with a phase shift of 90°.

Advantageously, the first coupler CPRx is connected between the earth remote control antenna Rx+Z and the anti-earth remote control antenna Rx-Z. The second coupler CPTx is connected between the earth remote measurement antenna Tx+Z and the anti-earth remote measurement antenna Tx-Z.

The first coupler CPRx and the second coupler CPTx are furthermore electrically connected to the transponder TP.

This configuration allows the number of cables to be routed between the antenna system and the transponder TP to be minimized.

As a variant, it is possible to integrate the couplers into the transponder TP, and thus to connect each of the antennas to the transponder TP.

The platform PF may also comprise an arm BR forming an extension of the platform PF in the plane of the platform PF. The arm BR, visible in particular in FIG. 5, allows the “scattering” phenomenon caused by the solar panel PS to be further reduced, even if the arm is not perfectly aligned with the edge of the solar panel, with respect to the scenario where the antenna system is disposed in one corner of the platform at the foot of the solar panel PS.

The arm BR is disposed along an axis AX (FIG. 3) corresponding to the junction between the platform PF and the solar panel PS. The antenna system is then disposed on the said arm BR of the platform PF, it being understood that the earth remote control antenna Rx+Z and the anti-earth remote control antenna Rx-Z are disposed on either side of the arm BR. The same applies to the earth remote measurement antenna Tx+Z and the anti-earth remote measurement antenna Tx-Z.

The arm BR forms an extension of the platform PF; the thickness of the arm corresponds to the thickness of the platform PF. In this way, the antennas of the same antenna pair (remote measurement or remote control antennas) indeed remain separated by a distance less than λ.

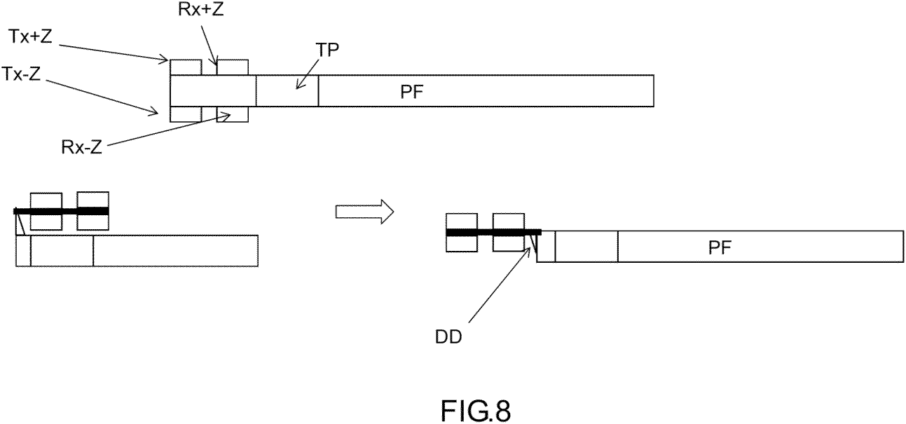

In order to facilitate the integration of the satellite into the shroud of the rocket, it may be advantageous to provide a device DD for deployment of the arm BR, illustrated in FIG. 8. It is important to guarantee the reliability of the deployment of the arm BR when the satellite is in orbit. Indeed, the consequence of the back to back configuration of the antennas is that, in the case of failure of the deployment, one of the two antennas could be totally unusable, which could adversely affect the remote control or remote measurement link.

With a view to making the deployment more reliable, the deployment device DD may be equipped with a low-impact passive system. A low-impact passive system is a deployment system using one or more springs, as opposed to an active system conventionally composed of a stepper motor. In a low-impact passive system, it is the tension in the spring which enables the deployment of the structure.

The invention thus allows the equivalent isotropic radiated power (EIRP) performance in transmission, and the figure of merit (G/T) in reception, to be improved by offering a better stability of the signal with the change in attitude of the platform, and by thus increasing the addressable field of view (no oscillations within a certain angular range).

In a reciprocal manner, to iso-EIRP or iso-G/T, the invention allows the power of the transponder to be reduced, which allows a reduced heat dissipation to be obtained and enables a more competitive amplification system to be integrated. Since the power is reduced, the corona effect is less of a problem.

1. A satellite (SAT) comprising a platform (PF), at least one solar panel (PS) for supplying the satellite (SAT) with electrical energy, the solar panel (PS) being fixed along one side of the platform (PF), the satellite comprising an antenna system (Rx+Z, Rx-Z, Tx+Z, Tx-Z) comprising two remote control antennas (Rx+Z, Rx-Z) and two remote measurement antennas (Tx+Z, Tx-Z), wherein:
the two remote control antennas (Rx+Z, Rx-Z) are disposed back to back on either side of the platform, and spaced one from the other by a distance less than or equal to λ, where λ corresponds to the wavelength of the remote control or remote measurement signal,
the two remote measurement antennas (Tx+Z, Tx-Z) are disposed back to back, on either side of the platform, and spaced one from the other by a distance less than or equal to λ,
the antenna system is disposed at one of the two ends of the side of the platform (PF) on which the solar panel (PS) is fixed.

2. The satellite according to claim 1, wherein the platform (PF) comprises a transponder (TP), the transponder (TP) being adjacent to the antenna system (Rx+Z, Rx-Z, Tx+Z, Tx-Z).

3. The satellite according to claim 2, wherein the two remote control antennas (Rx+Z, Rx-Z) are disposed between the transponder (TP) and the two remote measurement antennas (Tx+Z, Tx-Z).

4. The satellite according to claim 2, wherein the transponder (TP) is disposed between the two remote control antennas (Rx+Z, Rx-Z) and the two remote measurement antennas (Tx+Z, Tx-Z).

5. The satellite according to claim 1, wherein the platform (PF) comprises an arm forming an extension of the platform (PF) in the plane of the platform (PF), along an axis (AX) corresponding to the junction between the platform (PF) and the solar panel (PS), the antenna system (Rx+Z, Rx-Z, Tx+Z, Tx-Z) being disposed on the said arm (BR) of the platform (PF).

6. The satellite according to claim 5, wherein the arm (BR) of the platform comprises a deployment device (DD), the said deployment device (DD) being equipped with a low-impact passive system.

7. The satellite according to claim 1, wherein the satellite comprises a first coupler (CPRx) configured for summing signals coming from the remote control antennas (Rx+Z, Rx-Z), a second coupler (CPTx) configured for distributing a remote measurement signal to the remote measurement antennas (Tx+Z, Tx-Z), the first coupler (CPRx) and the second coupler (CPTx) being respectively connected between the remote control antennas (Rx+Z, Rx-Z), and between the remote measurement antennas (Tx+Z, Tx-Z).
